(19) United States
(12) Patent Application Publication
(10) Pub. No.: US 2026/0044640 A1
(43) Pub. Date: Feb. 12, 2026

(54) SYSTEM AND METHOD FOR AUTOMATING SEAT-TO-SEAT HARNESS ROUTING

(71) Applicant: B/E Aerospace, Inc., Winston-Salem, NC (US)

(72) Inventors: Krishna Prathipati, Hyderabad (IN); Ganesh Pralhad Bawaskar, Hyderabad (IN); Rajesh Dube, Hyderabad (IN)

(21) Appl. No.: 19/282,552

(22) Filed: Jul. 28, 2025

(30) Foreign Application Priority Data
Aug. 7, 2024 (IN) 202411059705

(51) Int. Cl. G06F 30/15; G06F 30/12; G06F 113/16

(52) U.S. Cl. CPC G06F 30/15; G06F 30/12; G06F 2113/16

(57) ABSTRACT

A system and method for automated seat-to-seat routing in an aircraft is disclosed. The system may include a user interface configured to receive user input data and a controller communicatively coupled to the user interface. The system may be configured to acquire a set of requirements corresponding to an aircraft seat cable design environment, acquire boundary coordinates defining a limited space for generating cable routings, acquire two or more nominal length routings for different cables, generate a set of overlength routings for each cable, output the overlength routings for user selection, acquire a selected cable routing for each cable, and update the aircraft seat cable design environment based on the selected cable routings.

### CROSS-REFERENCE TO RELATED APPLICATIONS

The present application claims the benefit of India Provisional Patent Application 202411059705, filed Aug. 7, 2024, titled SYSTEM AND METHOD FOR AUTOMATING SEAT-TO-SEAT HARNESS ROUTING, which is incorporated herein by reference in the entirety.

### TECHNICAL FIELD

The present disclosure relates generally to cable routing, and, more particularly, to automated cable routing.

### BACKGROUND

Designing seat-to-seat routing of cables in an aircraft presents many potential issues. As the complexity and number of connections and configurations and constraints grow, the number of possibilities for routing the cables grow exponentially. Meeting all of the requirements may take a lot of time, effort, and iterations. In some cases, it may be impossible to meet all given requirements and standards but it may take many hours for an engineer to make such a determination. In some scenarios, the standards may need to be deviated from.

Therefore, there is a need for a system and method that can provide an efficient way to design and evaluate cable routing.

### SUMMARY

A system for automated seat-to-seat routing in an aircraft is disclosed in accordance with one or more illustrative embodiments of the present disclosure. In one illustrative embodiment, the system may include a user interface configured to receive user input data and a controller communicatively coupled to the user interface. In another illustrative embodiment, the controller may include one or more processors configured to execute a set of program instructions stored in a memory. In another illustrative embodiment, the set of program instructions may be configured to acquire a set of requirements corresponding to an aircraft seat cable design environment, which includes at least a three-dimensional geometry of an aircraft seat. In another illustrative embodiment, the user interface may be used to acquire boundary coordinates defining a limited space for generating cable routings and to acquire two or more nominal length routings for different cables, each routing including a three-dimensional routing of a cable with specific end coordinates and angled orientations.

In another illustrative embodiment, the program instructions may generate, for each cable of the two or more cables, a set of overlength routings based on the first end coordinates, the first angled orientation, the nominal length of the cable, the second end coordinates, and the second angled orientation of each cable, maintaining a minimum bend radius. In another illustrative embodiment, the system may output, via a display, the set of overlength routings for user selection and acquire, via the user interface, a selected cable routing for each cable based on the set of overlength routings. In another illustrative embodiment, the system may update the aircraft seat cable design environment based on the plurality of selected cable routings.

In further aspects, the set of requirements may include an aircraft type and predefined standards for a specific aircraft manufacturer. In another illustrative embodiment, the set of program instructions may be further configured to automatically select cable interfaces between aircraft seats based on the selected cable routing, regenerate the set of overlength routings in response to a user modification of a respective nominal length routing, suggest changes in nominal position and orientation of cable ends when the set of overlength routings does not meet the set of requirements, output design recommendations for geometric shapes of mechanical components in proximity to cable interfaces based on the selected cable routing, validate that the selected cable routing complies with all of the set of requirements for the aircraft seat cable design environment, and generate a bill of materials based on the selected cable routing and the aircraft seat cable design environment.

A method for automated seat-to-seat routing in an aircraft is disclosed in accordance with one or more illustrative embodiments of the present disclosure. In one illustrative embodiment, the method may include acquiring a set of requirements corresponding to an aircraft seat cable design environment, which includes at least a three-dimensional geometry of an aircraft seat. In another illustrative embodiment, the method may include acquiring, via a user interface, boundary coordinates defining a limited space for generating cable routings. In another illustrative embodiment, the method may include acquiring, via a user interface, two or more nominal length routings for different cables, each comprising a three-dimensional routing design of a cable. In another illustrative embodiment, the method may include generating a set of overlength routings for each cable based on various parameters such as first and second end coordinates, first and second angled orientations, and the nominal length of the cable, where each overlength routing maintains a minimum bend radius. In another illustrative embodiment, the method may include outputting, via a display, the set of overlength routings for user selection. In another illustrative embodiment, the method may include acquiring, via the user interface, a selected cable routing for each cable based on the set of overlength routings. In another illustrative embodiment, the method may include updating the aircraft seat cable design environment based on the selected cable routings.

In a further aspect, the set of requirements may include an aircraft type. In another aspect, generating the set of overlength routings may include generating at least six different overlength routing options. In another aspect, the method may further include selecting, via a controller, cable interfaces between aircraft seats based on the selected cable routing. In another aspect, the method may further include regenerating the set of overlength routings in response to a user modification of a respective nominal length routing. In another aspect, the set of requirements may include predefined standards for a specific aircraft manufacturer. In another aspect, the method may further include suggesting, via the display, a change in nominal position and orientation of the first end or the second end when the set of overlength routings does not meet the set of requirements. In another aspect, the method may further include outputting design recommendations for geometric shapes of mechanical components in proximity to cable interfaces based on the selected cable routing. In another aspect, the method may further include validating that the selected cable routing complies with all of the set of requirements for the aircraft seat cable design environment. In another aspect, the method may further include generating a bill of materials based on the selected cable routing and the aircraft seat cable design environment.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples of the present disclosure are disclosed in the following detailed description and the accompanying drawings. The drawings are not necessarily to scale. In general, operations of disclosed processes may be performed in an arbitrary order, unless otherwise provided in the claims.

FIG. 1 is a conceptual block diagram of a system for cable routing generation, in accordance with one or more embodiments of the present disclosure.

FIG. 2 is a portion of a top-down view diagram showing simplified routings and interfaces and raceways of a seating arrangement of seats, in accordance with one or more embodiments of the present disclosure.

FIG. 3A is a diagram of a nominal length routing and a set of overlength routings with a cable interface in a nominal position, in accordance with one or more embodiments of the present disclosure.

FIG. 3B is a diagram of a suggested position of the cable interface of FIG. 3A and corresponding updated overlength routings based on the suggested position, in accordance with one or more embodiments of the present disclosure.

FIG. 4 is an aircraft seat cable design environment as displayed on display and comprising sets of overlength routings for various cables, in accordance with one or more embodiments of the present disclosure.

FIG. 5A is an aircraft seat cable design environment, in accordance with one or more embodiments of the present disclosure.

FIG. 5B is the aircraft seat cable design environment of FIG. 5A and a generation boundary used to generate the overlength routings, in accordance with one or more embodiments of the present disclosure.

FIG. 6 is a set of overlength routings with a cable interface configured for cable inputs on opposing sides of the cable interface, in accordance with one or more embodiments of the present disclosure.

FIG. 7 is a process flow diagram depicting a method 700, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

Typically, engineers are putting considerable time and effort into routing aircraft seat cables manually, which may include packaging them in the limited space available in the seats. This may be especially true for economy and premium economy class. Routing typically requires many iterations to match the requirements of airframers. Aircraft manufacturers themselves may require a set of multiple overlength cable designs to make sure real time scenario can be met.

Broadly speaking, embodiments of the concepts disclosed herein are directed to a system and method for automating the process of designing complex cable configurations. In embodiments, the system is configured to generated overlengths based on a user's initial nominal length of cables and a set of constraints/requirements, such as an airframer set of constraints. In this way, the system may translate raw user inputs into practical 3D routing options and to display those on a GUI for selection by the user. For instance, the system may allow for automatic compliance of routing requirements, reducing human error. The system may be configured to initially receive a user input of nominal routings for the cables for each cable. Then the system may generate a set of “overlength” routings to choose from for each cable based on the length of the nominal routing and the orientation of the endpoints of the routings. The nominal routing may, in a sense, provide a starting point for the generation of the overlength routings.

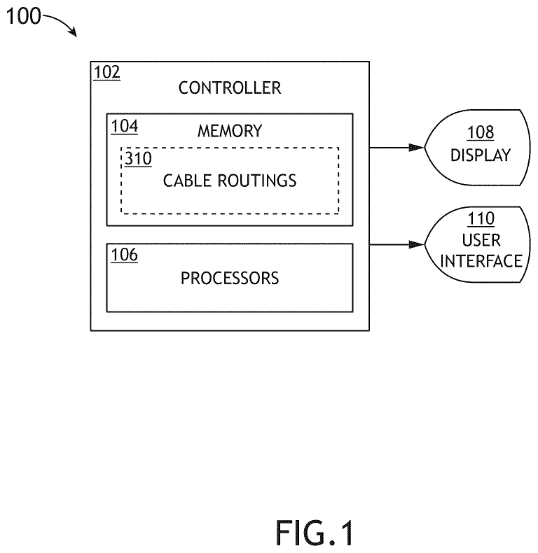

FIG. 1 illustrates a conceptual block diagram of a system 100 for cable routing generation, in accordance with one or more embodiments of the present disclosure.

In embodiments, the system 100 for automated seat-to-seat cable routing in an aircraft includes a display 108 configured to display a graphic user interface (GUI). For example, the display 108 may be used to display an aircraft seat cable design environment. For instance, the aircraft seat cable design environment may be any three-dimensional environment, such as a computer aided design (CAD) software configured to design, model, orientate, and/or the like various three-dimension components such as aircraft seats, cables, aircraft interiors, and the like.

In embodiments, the system 100 includes a user interface 110 configured to receive user input data via a user (e.g., a human engineer). For example, the user interface 110 may include a mouse, keyboard, microphone, and/or the like.

The system 100 may be any system. For example, the system 100 may be a CAD system configured for computer aided design (CAD) of three-dimension designs.

In embodiments, the system 100 includes a controller 102. The controller 102 may be communicatively coupled to the user interface 110 and the display 108. The controller 102 may include one or more processors 106. The one or more processors 106 may be configured to execute a set of program instructions stored in a memory 104. For example, the program instructions may include programming code of a design software application.

The memory 104 may be configured for storing data, such as the program instructions and cable routings 310.

Cable routings 310 may correspond to the length, size, orientation, path, and/or the like of a cable. For example, cables may be flexible components configured to transmit electrical power and/or signals. For example, a cable routing may include waypoint coordinates, geometric formulas, cable paths, and/or the like in three dimensions. For instance, the cable routing may be a 3D line pathway with multiple curves, each curve having a bend radius, and/or the like.

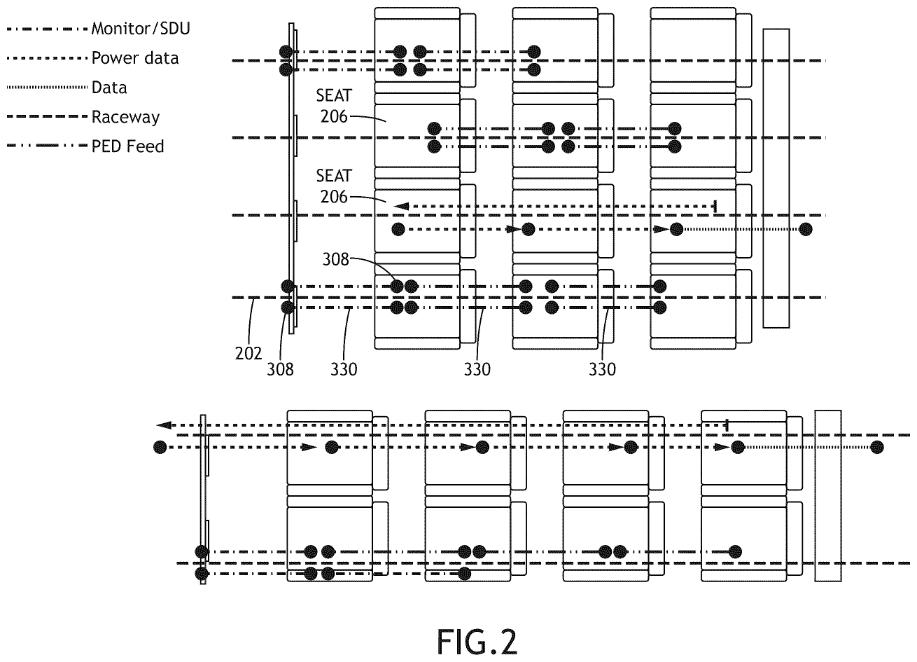

FIG. 2 illustrates a portion of a top-down view diagram showing simplified routings and interfaces 308 of cables 330, and raceways 202 of a seating arrangement of aircraft seats 206, in accordance with one or more embodiments of the present disclosure.

FIG. 2 may aide in understanding the complexity of a large cable routing project. Note that FIG. 2 only shows a portion of the project, and the project may include many times the number of cables and seats and complexity shown in FIG. 2.

Referring to FIG. 2, as requirements change, then design can become exponentially difficult to maintain. For example, a newly added cable 330 being connected to an existing interface connection 308 may cause an unavoidable interference with a frame portion of a seat that occurs due to having a minimum bend radius of the newly added cable. This interference may not have been anticipated when the interface location was first determined. The user may wish to move a cable interface/plug to accommodate the new cable. This may require needing to spend a lot of time updating all of the dependent child cables and interface locations that depend on that interface location.

So, if even a single cable interface/plug 308 is moved as the design evolves, then it can have a downstream effect on many other intermediate cable routing contexts and interfaces. Each interface, cable, seating arrangement and/or the like may need to be changed to meet a set of requirements, such as minimum bend radius, changing seat geometry/type, changing connection interface orientations and positions, and/or the like.

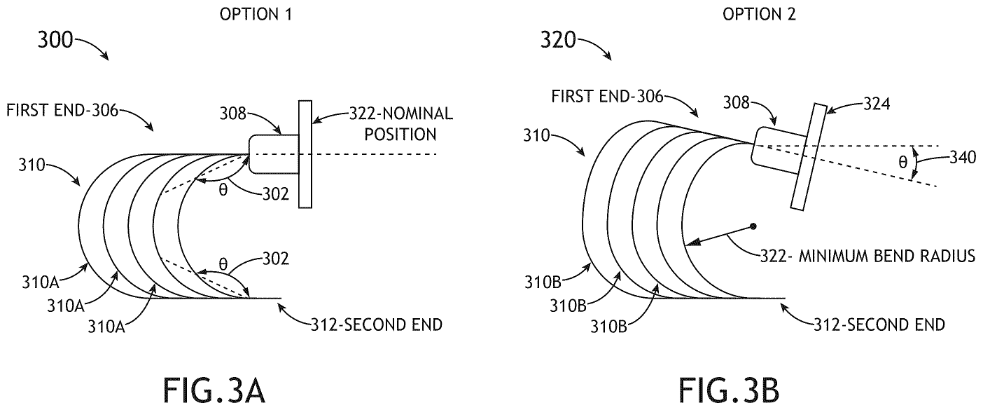

FIG. 3A illustrates a diagram 300 of a nominal length routing 304 and a set of overlength routings 310 with a cable interface 308 in a nominal position 322, in accordance with one or more embodiments of the present disclosure.

A three-dimensional routing of a cable 330 is shown. The three-dimensional routing may include: a first end coordinates (e.g., X, Y, Z coordinates) of a first end 306 of the cable 330 at a first cable interface 308 (e.g., plug, cable connection point); a first angled orientation (e.g., 3D vector angles) of the first end 306 of the cable 330; a nominal length (e.g., calculated length of the nominal cable routing as manually created by a user) of the cable; second end coordinates of a second end 312 at a second cable interface (not shown); and a second angled orientation of the second end 312 of the cable 330.

The overlength routings 310 may be based on the nominal length routing 304. For example, the nominal position 322 and angles 302 of the interface 308 of each end 306, 312 of the nominal length routing 304 may be used to generate the overlength routings 310. For example, in a simple scenario as shown, the overlength routings 310A may simply be the same positions and orientations of the first end 306 and the second end 312, but longer lengths. For instance, any length change may be used such as predefined constant length increases (e.g., half an inch or more increments), pre-defined percentage-based increases (e.g., +10%, +20%), incremental rounded numbers (e.g., to the nearest unit/inch/centimeter), and/or the like. For instance, the generated lengths may be in increments, such as 5% or more sized increments between each other. For example, 105% of the nominal length, 110% of the nominal length, 115% of the nominal length, and/or the like.

FIG. 3B illustrates a diagram 320 of a suggested position 324 of the cable interface 308 of FIG. 3A and corresponding updated overlength routings 310 based on the suggested position 324, in accordance with one or more embodiments of the present disclosure.

In an optional step, the set of program instructions may be further configured to cause the one or more processors 106 to suggest a change in nominal position 322 and orientation (e.g., nominal 3D vector angle of interface 308) of the first end 306 or the second end 312 when the set of overlength routings 310 (overlength routings 310A) does not meet the set of requirements. For example, new overlength routings 310B may therefore be configured to be generated. For example, if the length of the overlength routings 310A are impossible to meet a threshold minimum bend radius due to ends being too close and not enough length, then the system 100 may be configured to suggest a (new) suggested position 324 of the interface 308. In addition, and/or alternatively, the system 100 may be configured to generate a suggested orientation 340 of the interface 308. For instance, the program instructions may be configured to brute force a solution until a solution meeting the requirements is found. For example, the program instructions may be configured to randomly try different incremented angles and positions, such as changing the orientation 340 by 20 degrees away from the second end 312 and checking if the requirements are thereafter met.

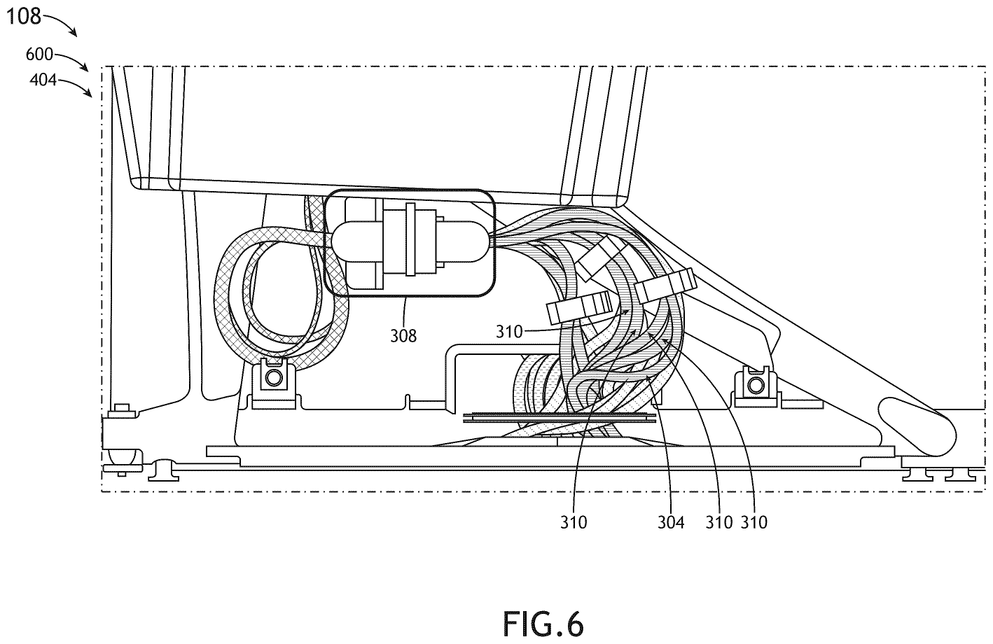

In some embodiments, the system 100 is configured to propagate a generation to other cables and cable interfaces based on a generation of a suggested position 324 and suggested orientation 340. For example, the system 100 may be configured to generate child overlength routings for any child cables 330 affected by the suggested position 324 and suggested orientation 340. For example, the system 100 may be configured to generate child positions and orientations for any child cable interfaces affected by the suggested position 324 and suggested orientation 340. An example of a child cable is the cable (unlabeled) on the left side of the dual-sided interface 308 of FIG. 6.

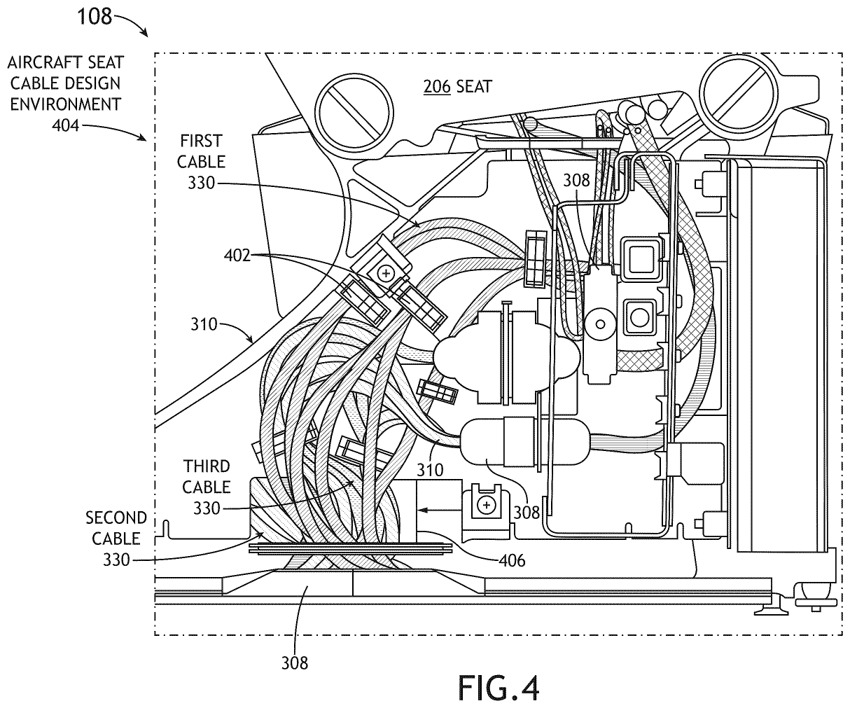

FIG. 4 illustrates an aircraft seat cable design environment 404 as displayed on display 108 and comprising sets of overlength routings 310 for various cables 330, in accordance with one or more embodiments of the present disclosure.

The generating of the overlength routings 310 may be based on one or more cable guides 402 (e.g., cable clamps or holes or the like). For example, the cable guides 402 may be pre-determined/fixed and/or able to be automatically moved and orientated during the generating step.

For instance, as shown, overlength routings 310 of a first cable 330 are configured to be automatically routed through one or more cable guides 402 depending on lengths of the overlength routings 310. For instance, as the lengths increase, longer overlength routings 310 may be routed through cable guides 402 that are farther away from the interfaces 308 corresponding to those cable routings 310. This makes sense as longer cables 330 may need to be farther away to take up extra slack and to maintain minimum bend radius.

In an optional step, the set of program instructions may be further configured to cause the one or more processors 106 to output design recommendations for geometric shapes of mechanical components in proximity to cable interfaces 308. For example, cutaway 406 may be oversized initially and configured to be dynamically modifiable based on the routings. For instance, after overlength routings 310 are selected by a user, seat component edge 406 may be configured to change in size to accommodate the selected routings. For example, as shown, the component edge 406 may be moved inwards towards the cable routings 310 with an added margin distance from each cable routing 310 for clearance. For example, the component edge 406 may be moved to within 1 inch of selected routings 310. This may help in automatically optimizing one or more shapes, sizes of one or more features of one or more aircraft seat components based on where the selected cable routing paths are located.

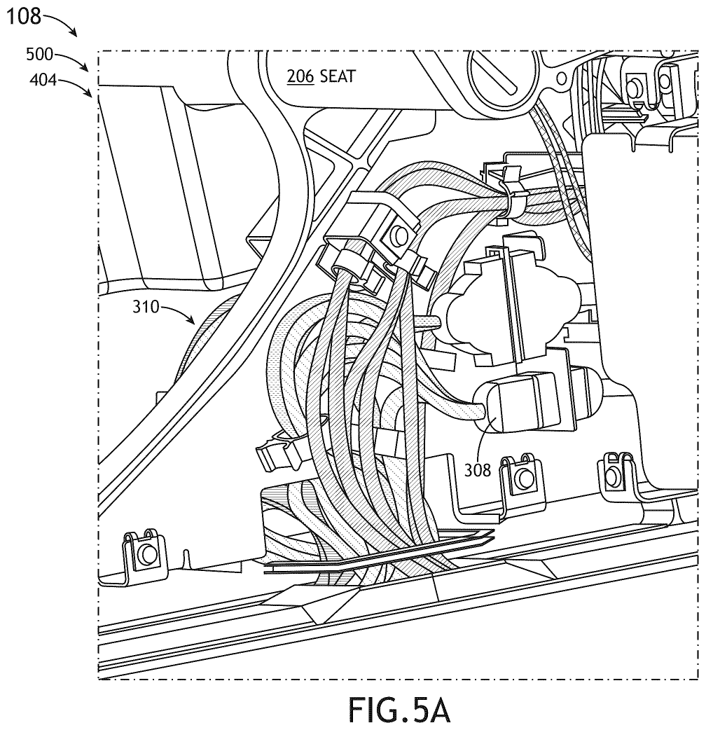

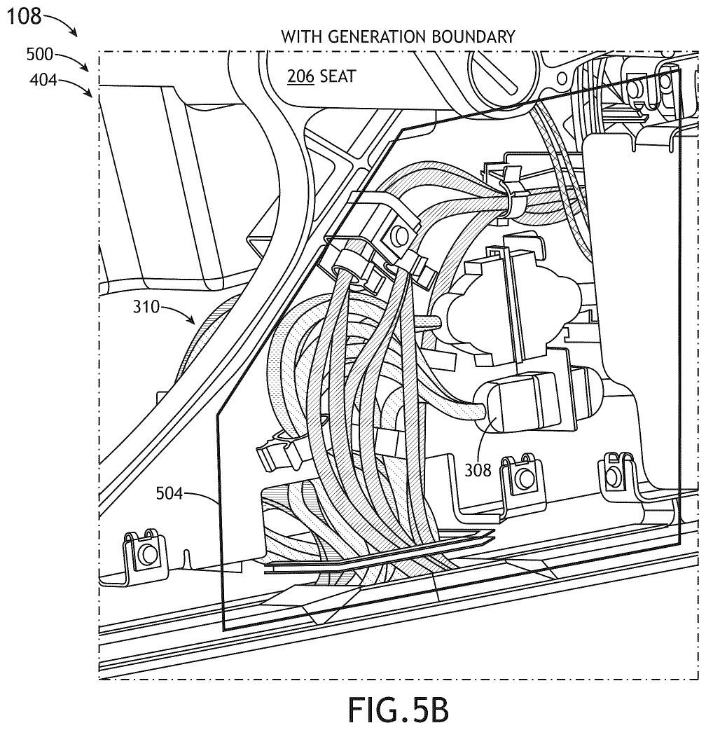

FIG. 5A illustrates a view 500 of an aircraft seat cable design environment 404, in accordance with one or more embodiments of the present disclosure. FIG. 5B illustrates a view 500 of the aircraft seat cable design environment 404 of FIG. 5A and a generation boundary 504 used to generate the overlength routings 310, in accordance with one or more embodiments of the present disclosure.

For example, the user may be prompted to input coordinates or a shape of a polygon defining the generation boundary 504. For instance, the generation boundary 504 may, as shown, be a two-dimensional shape in a flat plane. Although not shown, the generation boundary 504 may be defined to extend indefinitely normal (e.g., at 90 degrees) from the plane. When facing directly at the generation boundary 504, the generation boundary 504 may define a cross-sectional shape from which no overlength routing 310 will be generated to extend past. Note that the generation boundary 504 shown is merely an example and the generation boundary 504 can be any shape, such as a three-dimensional box, irregular three-dimensional shape, and/or the like.

FIG. 6 illustrates a view 600 of a set of overlength routings 310 with a cable interface 308 configured for cable inputs on opposing sides of the cable interface 308, in accordance with one or more embodiments of the present disclosure. FIG. 6 illustrates how different overlength routings 310 may change the shape of the cable.

Also note that the cable interface 308 is configured to receive a cable input on each side for a total of two cable inputs. Such a multi-input interface means that the movement of a suggested position the cable interface 308 to accommodate one cable may cause the connection to a different cable on the opposing side to be affected. This may make designing such routings manually difficult and inefficient.

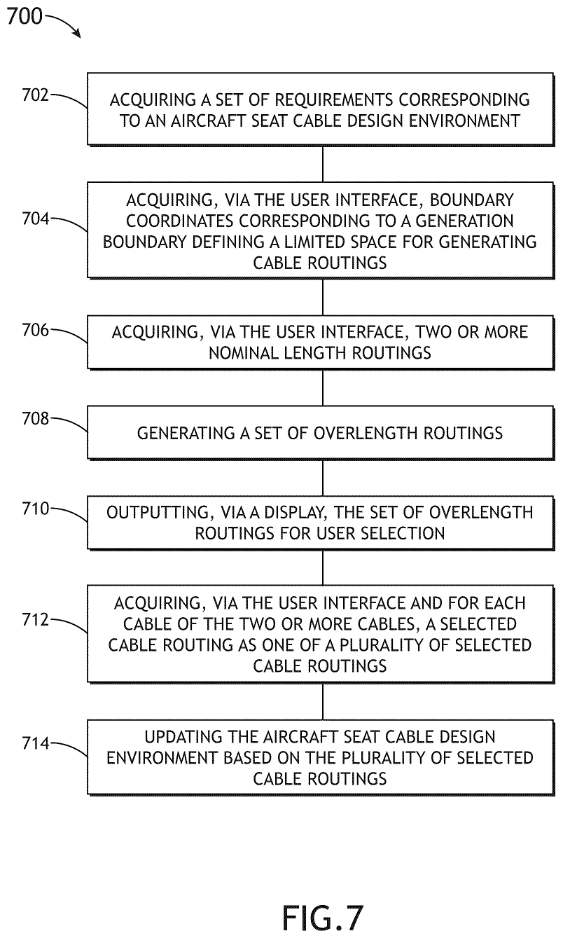

FIG. 7 illustrates a process flow diagram depicting a method 700, in accordance with one or more embodiments of the present disclosure. It is noted that the embodiments and enabling technologies described previously herein in the context of the system 100 should be interpreted to extend to the method 700. It is further noted herein that the steps of method 700 may be implemented all or in part by system 100. It is further recognized, however, that the method 700 is not limited to the system 100 in that additional or alternative system-level embodiments may carry out all or part of the steps of method 700.

At step 702, a set of requirements corresponding to an aircraft seat cable design environment 404 are acquired. For example, the set of requirements may be computer data stored in memory 104 and received from a database, input by a user, and/or the like.

The set of requirements may include an aircraft type (e.g., B777, B737, A350, A321 etc.), such as three-dimensional geometry of a Boeing or Airbus aircraft desired to be designed for by the user. The selection of aircraft type may also be configured to include other requirements such as seating arrangements, constraints, standards, types of cable interfaces, types of cables, required geometrical clearances, and/or the like.

The set of requirements may include a seat type (e.g., MIQ, ASPIRE, MERIDIAN, PINACLE, SFC), such as three-dimensional geometry. The selection of aircraft seat may also be configured to include other requirements such as constraints, standards, types of cable interfaces, types of cables, required geometrical clearances, and/or the like.

The set of requirements may include any geometric constraints, such as those specified by an aircraft manufacturer. For example, but not limited to such an example, the constraints may specify a minimum bend radius. For example, but not limited to such an example, the constraints may specify a minimum distance from other components for certain types of cables, such as a distance from heat generating components of an aircraft seat or the like. In some embodiments, the generation boundary 504 is also based on such requirements, such as the generation boundary 504 automatically including boundaries around seat geometry based on required distances from that geometry. The set of requirements may include predefined standards for a specific aircraft manufacturer, such as aircraft seat and cable routing design standards or the like.

At step 704, boundary coordinates corresponding to a generation boundary 504 defining a limited space for generating cable routings (e.g., overlength routings 310) are acquired via the user interface 110. For example, the application may be configured to receive coordinates of a polygon defining the limited space for generating cable routings. The controller 102 may be configured to only generate overlength routings 310 completely contained within the generation boundary 504. This may allow the controller 102 to generalize and have flexibility in the generation while still giving the user control over how the generation is made. This may significantly speed up design and provide a higher likelihood of proper generations that meet the requirements. The generation boundary 504 may be referred to as a “keep-in generation boundary”.

At step 706, two or more nominal length routings 304 are acquired via the user interface 110. Each of the two or more nominal length routings 304 may correspond to a different cable 330 of two or more cables 330. So if there are three cables 330 in the real-world, then each cable 330 would have its own set of overlength routings 310 generated based on a user-generated nominal length routing 304. Each of the two or more nominal length routings 304 may include a three-dimensional routing design of a cable 330. The three-dimensional routing design of the cable 330 may include first end coordinates of a first end 306 of the cable 330 at a first cable interface 308. The three-dimensional routing design of the cable 330 may include a first angled orientation of the first end 306 of the cable 330. The three-dimensional routing design of the cable 330 may include a nominal length of the cable 330. The three-dimensional routing design of the cable 330 may include second end coordinates of a second end 312 of the cable 330 at a second cable interface 308. The three-dimensional routing design of the cable 330 may include a second angled orientation of the second end 312 of the cable 330.

At step 708, a set of overlength routings 310 is generated for each cable 330 of the two or more cables 330 based on at least the first end coordinates, the first angled orientation, the nominal length of the cable 330, the second end coordinates, and the second angled orientation of each cable 330. Each overlength routing 310 may maintain a minimum bend radius.

Generating the set of overlength routings 310 may include generating at least four different overlength routing options 310A. Generating the set of overlength routings 310 may include generating at least six different overlength routing options 310A.

During the generating, the method may include (e.g., the set of program instructions may be further configured to cause the one or more processors 106 to) automatically select cable interfaces 308 between aircraft seats 206. For example, this may be performed based on the selected cable routing and/or automatically before such a selection. For instance, referring to FIG. 2, there may be multiple cable interfaces 308 available, and the system 100 may be configured to select one based on various factors such as connection availability (e.g., how many connections/cable-plugs on the interface 308 are unused), proximity/reachability, and compatibility with parameters such as minimum bend radius and respective length of a particular overlength routing 310 being generated.

Also note that the generating of step 708 below may take place in the entire aircraft. For example, the generating may be based on a plurality of generation boundaries 504, such as one or more generation boundaries 504 for each seat.

The path/shape of the overlength routing 310 may be based on any cable routing algorithm known in the art. For example, the path/shape may be based on a known length, and a minimum bend radius, with initial endpoint positions and orientations and/or the like. Various CAD software includes, in at least a simplified manner, three-dimensional cable routing generators between two points. For example, Dijkstra's algorithm could be used for solving single-source shortest path problems for directed or undirected paths. Single-source means that one vertex is chosen to be the start, and the algorithm will find the shortest path from that vertex to all other vertices. A form of such a shortest path algorithm could be used, where each cable guide 402 of FIG. 4 is a node, and the algorithm is configured to try a combination of one or more nodes to model the possible pathways between endpoints, or the like. For instance, in a simplified logic example, using such an algorithm it may be calculated that the shortest pathway to go through a particular cable guide is 20 inches. However, it may also be known that the length of the longest overlength is calculated to be 18 inches. Then it can logically be concluded using program instructions (e.g., if/then statements) that such a cable guide in such a position should not be routed through when generating the overlength routing. Alternatively, if the overlength routing length is 30 inches, then the controller 102 may be configured to use, or at least consider, that particular cable guide when routing. Note that the actual logic of the program instructions may account for a variety of things, such as but not limited to, minimum bend radius to route through any nodes, alternate nodes to route through, and/or the like.

Note that generative artificial intelligence (AI) may also be used. For example, a machine learning model comprising weights of virtual neurons may be trained using input and output training pairs to generate three-dimensional cable routing paths based on said inputs. For example the inputs may include at least the first end coordinates, the first angled orientation, the nominal length of the cable, the second end coordinates, and the second angled orientation of each cable 330, wherein each overlength routing maintains a minimum bend radius and the outputs may include overlength routings 310.

The minimum bend radius may be known by the controller 102, such as being based on the type (e.g., thickness) of cable 330 being routed and/or the minimum bend radius may be input via the user interface 110.

At step 710, the set of overlength routings 310 is output via a display 108 for user selection. For example, the controller 102 may be configured to direct the display 108 to show to a user the view 600 as a GUI. In such a scenario, the overlength routes 310 shown in FIG. 6 and the other figures may be graphical indicia of overlength routes 310 for selection purposes by a user. Benefits of such a display and selection may include, but are not limited to, enabling efficient and accurate cable routing design in complex three-dimensional aircraft environments, reducing design time and errors, optimizing cable lengths to minimize weight and material costs, ensuring compliance with minimum bend radius requirements, and facilitating real-time collaborative design processes. This automated approach allows designers to quickly evaluate and select optimal routings that may not be apparent through manual calculation or visualization, particularly in tight spaces with multiple constraints. Furthermore, the system's integration of user-selected routings into the aircraft seat cable design environment enables immediate feedback on the impact of routing choices on overall system design, supporting iterative optimization that would be impractical with traditional methods.

At step 712, a selected cable routing is acquired via the user interface 110 for each cable 330 of the two or more cables 330 based on the set of overlength routings 310. In other words, the user may select a particular overlength routing 310 they desire. The selected cable routing may be one of a plurality of selected cable routings, such as one selection for each cable 330.

At step 714, the aircraft seat cable design environment 404 is updated based on the plurality of selected cable routings. For example, the aircraft seat cable design environment 404 may be updated to only include the selected routings and to remove unselected routings. In this way, the user may quickly select and see what a final design would be with a selected set of routings.

In an optional step, for instance, the updating of step 714 may include displaying the (updated) aircraft seat cable design environment 404 based on the plurality of selected cable routings on the display 108.

In an optional step, the set of program instructions may be further configured to cause the one or more processors 106 to regenerate the set of overlength routings 310 in response to a user modification of a respective nominal length routing 304 corresponding to the set of overlength routings 310. For example, for any reason, the user may modify the nominal routing 304, which may include modification of its nominal length, position or orientation of a cable interface 308, and/or any other modification. The system 100 may be configured to trigger a regeneration of potential overlength routings 310 based on the newly modified nominal routing 304. In embodiments, this may be configured to trigger a regeneration of any child/dependent/other overlength routings that are connected to and dependent on those overlength routings 310.

In an optional step, the set of program instructions may be further configured to cause the one or more processors 106 to validate that the selected cable routing complies with all of the set of requirements for the aircraft seat cable design environment 404. For instance, the generating step 708, in some embodiments, may not necessarily initially validate for all requirements. For instance, after a user selection the system 100 may be configured to check that all of the set of requirements for the aircraft seat cable design environment 404 are met. For example, results of the validation may be configured to be displayed in the GUI. For instance, a table of the set of requirements along with indicia (e.g., text) showing whether a particular routing passes or fails to meet each requirement may be configured to be displayed. This may make it easier for a user to optimize the design, such as adjusting the nominal length 304 and seeing if more or less of the overlength routings 310 fail or pass which requirements.

The set of program instructions may be further configured to cause the one or more processors 106 to generate a bill of materials based on the selected cable routing and the aircraft seat cable design environment 404. For example, the bill of materials may include a list of cables 330 and their lengths based on the selected routings.

Referring now to FIG. 1 in more detail, the one or more processors 106 of controller 102 may include any one or more processing elements known in the art. In this sense, the one or more processors 106 may include any microprocessor device configured to execute algorithms and/or instructions. In one embodiment, the one or more processors 106 may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium (e.g., memory 104). Moreover, different subsystems of the system 100 may include processor or logic elements suitable for carrying out at least a portion of the steps described throughout the present disclosure. Therefore, the above description should not be interpreted as a limitation on the present invention but merely an illustration.

The memory medium 104 may include any storage medium known in the art suitable for storing program instructions executable by the associated one or more processors 106. For example, the memory medium 104 may include a non-transitory memory medium. For instance, the memory medium 104 may include, but is not limited to, a read-only memory, a random access memory, a magnetic or optical memory device (e.g., disk), a magnetic tape, a solid state drive and the like. In another embodiment, it is noted herein that the memory 104 is configured to store one or more results from the system 100 and/or the output of the various steps described herein. It is further noted that memory 104 may be housed in a common controller housing with the one or more processors 106. In an alternative embodiment, the memory 104 may be located remotely with respect to the physical location of the processors and controller 102. For instance, the one or more processors 106 of controller 102 may access a remote memory (e.g., server), accessible through a network (e.g., internet, intranet and the like). In another embodiment, the memory medium 104 stores the program instructions for causing the one or more processors 106 to carry out the various steps described through the present disclosure.

All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

In another embodiment, the controller 102 of the system 100 may be configured to receive and/or acquire data or information from other systems by a transmission medium that may include wireline and/or wireless portions. In another embodiment, the controller 102 of the system 100 may be configured to transmit data or information (e.g., the output of one or more processes disclosed herein) to one or more systems or sub-systems by a transmission medium that may include wireline and/or wireless portions. In this manner, the transmission medium may serve as a data link between the controller 102 and other subsystems of the system 100. Moreover, the controller 102 may send data to external systems via a transmission medium (e.g., network connection).

In another embodiment, the system 100 includes a user interface. In one embodiment, the user interface is communicatively coupled to the one or more processors 106 of controller 102. In another embodiment, the user interface device may be utilized by controller 102 to accept selections and/or instructions from a user. In some embodiments, described further herein, a display may be used to display data to a user (not shown). In turn, a user may input, via user input device, a selection and/or instructions responsive to data displayed to the user via the display device.

The user interface device 110, which may be referred to as a user interface 110, may include any user interface known in the art. For example, the user input device of the user interface 110 may include, but is not limited to, a keyboard, a keypad, a touchscreen, a lever, a knob, a scroll wheel, a track ball, a switch, a dial, a sliding bar, a scroll bar, a slide, a handle, a touch pad, a paddle, a steering wheel, a joystick, a bezel input device or the like. In the case of a touchscreen interface device, those skilled in the art should recognize that a large number of touchscreen interface devices may be suitable for implementation in the present invention. For instance, the display device 108 may be integrated with a touchscreen interface, such as, but not limited to, a capacitive touchscreen, a resistive touchscreen, a surface acoustic based touchscreen, an infrared based touchscreen, or the like. In a general sense, any touchscreen interface capable of integration with the display portion of a display device is suitable for implementation in the present invention. In another embodiment, the user input device may include, but is not limited to, a bezel mounted interface.

The display device 108, which may be referred to as a display 108, may include any display device known in the art. In one embodiment, the display device 108 may include, but is not limited to, a liquid crystal display (LCD). In another embodiment, the display device 108 may include, but is not limited to, an organic light-emitting diode (OLED) based display. In another embodiment, the display device 108 may include, but is not limited to a CRT display. Those skilled in the art should recognize that a variety of display devices 108 may be suitable for implementation in the present invention and the particular choice of display device may depend on a variety of factors, including, but not limited to, form factor, cost, and the like. In a general sense, any display device 108 capable of integration with a user input device (e.g., touchscreen, bezel mounted interface, keyboard, mouse, trackpad, and the like) is suitable for implementation in the present invention.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A system for automated seat-to-seat routing in an aircraft, the system comprising:
a user interface configured to receive user input data via a user; and
a controller communicatively coupled to the user interface, the controller including one or more processors configured to execute a set of program instructions stored in a memory, the set of program instructions configured to cause the one or more processors to:
acquire a set of requirements corresponding to an aircraft seat cable design environment, wherein the set of requirements comprises at least a three-dimensional geometry of an aircraft seat;
acquire, via the user interface, boundary coordinates corresponding to a generation boundary defining a limited space for generating cable routings;
acquire, via the user interface, two or more nominal length routings, wherein each of the two or more nominal length routings corresponds to a different cable of two or more cables and comprises:
a three-dimensional routing of a cable comprising:
first end coordinates of a first end of the cable at a first cable interface;
a first angled orientation of the first end of the cable;
a nominal length of the cable;
second end coordinates of a second end of the cable at a second cable interface; and
a second angled orientation of the second end of the cable;
generate, for each cable of the two or more cables, a set of overlength routings based on at least the first end coordinates, the first angled orientation, the nominal length of the cable, the second end coordinates, and the second angled orientation of the each cable, wherein each overlength routing maintains a minimum bend radius;
output, via a display, the set of overlength routings for user selection;
acquire, via the user interface and for each cable of the two or more cables, a selected cable routing based on the set of overlength routings, wherein the selected cable routing is one of a plurality of selected cable routings; and
update the aircraft seat cable design environment based on the plurality of selected cable routings.

2. The system of claim 1, wherein the set of requirements comprise an aircraft type.

3. The system of claim 1, wherein generating the set of overlength routings comprises generating at least six different overlength routing options.

4. The system of claim 1, wherein the set of program instructions is further configured to cause the one or more processors to automatically select cable interfaces between aircraft seats based on the selected cable routing.

5. The system of claim 1, wherein the set of program instructions is further configured to cause the one or more processors to regenerate the set of overlength routings in response to a user modification of a respective nominal length routing corresponding to the set of overlength routings.

6. The system of claim 1, wherein the set of requirements includes predefined standards for a specific aircraft manufacturer.

7. The system of claim 1, wherein the set of program instructions is further configured to cause the one or more processors to suggest a change in nominal position and orientation of the first end or the second end when the set of overlength routings does not meet the set of requirements.

8. The system of claim 1, wherein the set of program instructions is further configured to cause the one or more processors to output design recommendations for geometric shapes of mechanical components in proximity to cable interfaces based on the selected cable routing.

9. The system of claim 1, wherein the set of program instructions is further configured to cause the one or more processors to validate that the selected cable routing complies with all of the set of requirements for the aircraft seat cable design environment.

10. The system of claim 1, wherein the set of program instructions is further configured to cause the one or more processors to generate a bill of materials based on the selected cable routing and the aircraft seat cable design environment.

11. A method for automated seat-to-seat routing in an aircraft, the method comprising:
acquiring a set of requirements corresponding to an aircraft seat cable design environment, wherein the set of requirements comprises at least a three-dimensional geometry of an aircraft seat;
acquiring, via a user interface, boundary coordinates corresponding to a generation boundary defining a limited space for generating cable routings;
acquiring, via the user interface, two or more nominal length routings, wherein each of the two or more nominal length routings corresponds to a different cable of two or more cables and comprises:
a three-dimensional routing design of a cable comprising:
first end coordinates of a first end of the cable at a first cable interface;
a first angled orientation of the first end of the cable;
a nominal length of the cable;
second end coordinates of a second end of the cable at a second cable interface; and
a second angled orientation of the second end of the cable;
generating, for each cable of the two or more cables, a set of overlength routings based on at least the first end coordinates, the first angled orientation, the nominal length of the cable, the second end coordinates, and the second angled orientation of the each cable, wherein each overlength routing maintains a minimum bend radius;
outputting, via a display, the set of overlength routings for user selection;
acquiring, via the user interface and for each cable of the two or more cables, a selected cable routing based on the set of overlength routings, wherein the selected cable routing is one of a plurality of selected cable routings; and
updating the aircraft seat cable design environment based on the plurality of selected cable routings.

12. The method of claim 11, wherein the set of requirements comprise an aircraft type.

13. The method of claim 11, wherein generating the set of overlength routings comprises generating at least six different overlength routing options.

14. The method of claim 11, further comprising selecting, via a controller, cable interfaces between aircraft seats based on the selected cable routing.

15. The method of claim 11, further comprising regenerating the set of overlength routings in response to a user modification of a respective nominal length routing corresponding to the set of overlength routings.

16. The method of claim 11, wherein the set of requirements includes predefined standards for a specific aircraft manufacturer.

17. The method of claim 11, further comprising suggesting, via the display, a change in nominal position and orientation of the first end or the second end when the set of overlength routings does not meet the set of requirements.

18. The method of claim 11, further comprising outputting design recommendations for geometric shapes of mechanical components in proximity to cable interfaces based on the selected cable routing.

19. The method of claim 11, further comprising validating that the selected cable routing complies with all of the set of requirements for the aircraft seat cable design environment.

20. The method of claim 11, further comprising generating a bill of materials based on the selected cable routing and the aircraft seat cable design environment.
